(19) United States
(12) Patent Application Publication
(10) Pub. No.: US 2010/0318596 A1
(43) Pub. Date: Dec. 16, 2010

(54) SYSTEMS AND METHODS FOR PROVIDING READILY UPDATABLE MEDIA CONTENT

(76) Inventor: Ann Bergman, Seattle, WA (US)

Correspondence Address: Patent Prep and Pros Group;Scott A. Schlack, 4632 159th St. S.W., Lynnwood, WA, 98087, US

(21) Appl. No.: 12/484,128

(22) Filed: Jun. 12, 2009

(51) Int. Cl. G06F 15/16

(52) U.S. Cl. 709/203

(57) ABSTRACT

A networked system facilitating the distribution of readily-updatable headline media content generated by the advertising client (or agent of the client) of the media content provider. The networked system includes a first server device, a second server device, one or more client devices, and a data communications network, facilitating data communications amongst the devices. The second server device provides an updatable media content service to both the first server device and a client device. The service allows a media content selection of the client device to be automatically presented within a media content module (on the first server device with little or no interaction between the first server device and the client.

### FIELD OF THE INVENTION

The present invention relates to media presentation services and advertising. More particularly, the invention relates to systems that facilitate the distribution of readily-updatable media content between media content providers and their clientele (or their agents). Using a third-party advertising service, clientele (or their agents) of a media content provider may automatically present a selected media content within a designated media content module at a media content provider website with little or no interaction on the part of the media content provider.

### BACKGROUND OF THE INVENTION

Many businesses as well as non-profit organizations have a wealth of ever-changing news information related to their services and/or products that they wish to share with potential customers or with members of the general public. To disseminate this news information businesses and organizations often compile and send a news release to the editors of one or more news media content (NMC) providers in the hope that the editor will choose to include the news contained in the news release in the NMC provider's editorial content.

As would be understood by those skilled in the art, a news release is generally an electronic or hard-copy recorded correspondence directed at members of the news media for the purpose of distributing a variety of news-worthy information. News releases may be transmitted to a NMC provider editor by mail, facsimile, e-mail, etc. A NMC provider may be affiliated with any of following media distribution services: newspapers, magazines, radio stations, television networks, informational websites, etc.

News releases can announce a variety of news-worthy topics, including, but not limited to: new or improved products and services, awards given or received by a business or non-profit, community service events, promotions, consumer information from businesses or non-profit organizations that draws on their expertise, research findings related to products and services, etc. A news release is generally focused towards the objectives of an author and it is often describing the who, what, when, where and why of an important event, program, or piece of information related to an individual or an organization. News releases may include at least the following components: a headline that is intended to attract the attention of viewers and briefly summarize an affiliated news content; an introduction/body that provides answers to the subject questions and offers further background, explanation, and/or other supplemental media (e.g., images, audio, audio-visual, etc.) relevant to the news content; and a contact information including a website address (e.g., a URL hyperlink), phone number, email address, mailing address, and/or other related contact information.

Presently, many businesses and non-commercial entities employ public relations and marketing specialists that send their news releases to editors at multiple and differing NMC providers. The public relations and marketing specialists may spend a good deal of time trying to convince editors that their client's news releases are worthy of being included in the editorial side of print or website publications. Whether or not the editor selects the content of a news release to be included in the editorial content of any or all of the NMC provider's affiliated website or print publications is entirely based on the discretion of the editor and may depend on factors such as editorial space available, time limitations of editor and writers, timeliness of news release and editorial focus of the NMC provider.

Furthermore, editorial content in all print publication is static in nature (e.g., is not able to be updated or edited in real-time) such that a news release that is received post print publication deadline will not be included. Due to these inefficiencies and limitations, businesses and not-for-profit organizations have no control over if, how, and when their particular news release content is shared with the viewers of NMC provider print publications and websites.

There are several powerful editorial-side publishing tools on the market today (e.g., various available publishing software) that allow NMC provider editors to easily change or add content to a print or website publication with minimal effort. For example, editors of certain news websites take advantage of these publishing tools by updating news websites with stories that first appeared in print, or posting new stories designated only for website publishing or posting and updating breaking news. This functionality of being able to easily add and update news content is a major benefit to the editorial side (e.g., changing news content at a particular NMC provider) of website publishing. At present this functionality has yet to become available to NMC provider clientele or their agents.

Accordingly, there remains a need for a truly dynamic, client-side publishing tool that facilitates the real-time updating of media content from a remote device location. It would be beneficial if this new publishing tool were simple to use and offered as an elective service to NMC providers and their clientele, including agencies acting on behalf of their clientele. Further, it would be desirable if the publishing tool allowed clientele to automatically affect selected media content on a NMC provider website with little or no NMC provider interaction required.

### SUMMARY OF THE INVENTION

In overcoming the above disadvantages associated with the prior art, a system for distributing readily-updatable media content made in accordance with the present invention includes, but is not limited to, a first server device, a second server device, one or more client devices, and a data communications network facilitating communications amongst the system devices. The second server device may provide an updatable media content service to the first server device and the one or more client devices, such that a media content selection of a client device is automatically presented within a news media content of the first server device.

In accordance with one aspect of the present invention, the media content selection may be textual headline data generated by a user of a client device.

In accordance with a further aspect of the invention, the media content selection within a news media content of the first server device may require little to no input from the first server device.

In accordance with yet another aspect of the invention, a linked media content may be presented in response to a user selection of the media content selection within the news media content of the first server device.

In accordance with another aspect of the invention the linked media content may be stored at the first server device.

In accordance with a further aspect of the invention, the user selection of the media content selection within the news media content of the first server device may link the user to a URL site including the linked media content.

In accordance with yet another aspect of the invention, the URL site comprising the linked media content may be associated with a website of a client device.

In accordance with yet a further aspect of the present invention is a computer-readable medium encoded with a set of computer-executable instructions that may executably perform a method for distributing readily-updatable media content. The method may include providing an updatable media content service to a first server device and a client device from a second server device over a data communications network, selecting a media content from the client device, and presenting the media content selection within a news media content of the first server device.

### DESCRIPTION OF THE DRAWINGS

Preferred and alternative examples of the present invention are described in detail below with reference to the following Figure drawings:

FIG. 1 illustrates a perspective view of a networked computing system in accordance with an embodiment of the present invention;

FIG. 2 illustrates a flowchart process associated with a News ADS service in accordance with an embodiment of the present invention;

FIG. 3 illustrates a News ADS Sellers Homepage in accordance with an embodiment of the present invention;

FIG. 4 illustrates a News ADS Client Homepage in accordance with an embodiment of the present invention;

FIG. 5 illustrates one view of a News Media Content provider website in accordance with an embodiment of the present invention;

FIG. 6 illustrates another view of a News Media Content provider website in accordance with an embodiment of the present invention; and

FIG. 7 illustrates a flowchart process associated with a News ADS service in accordance with an embodiment of the present invention.

### DETAILED DESCRIPTION

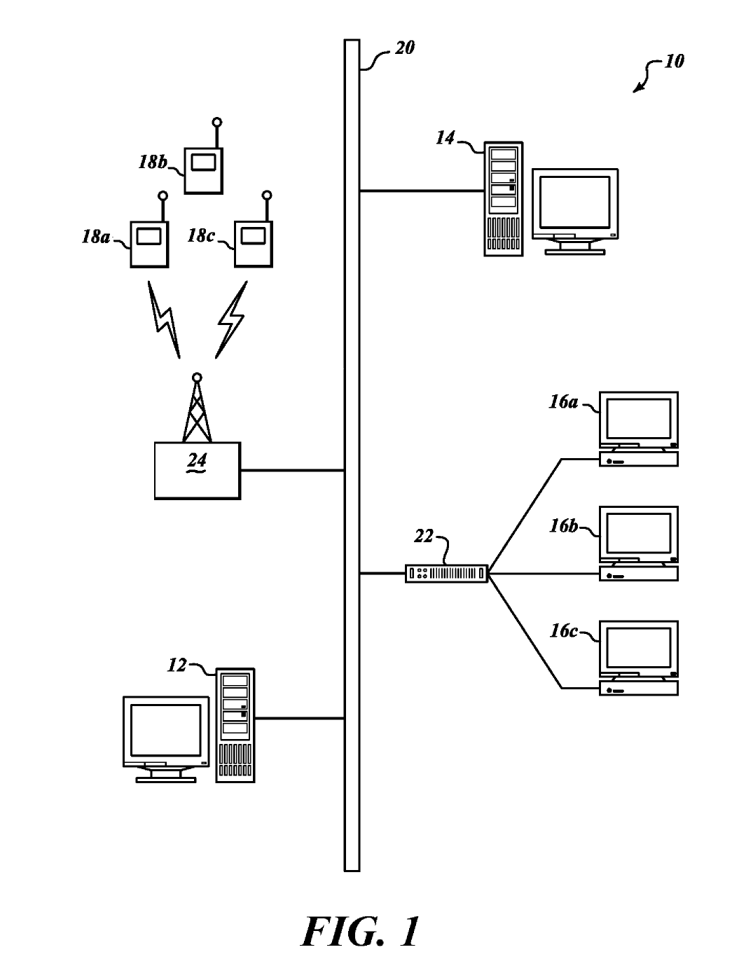

In accordance with an exemplary embodiment of the present invention, FIG. 1 illustrates a distributed computing system 10 including various wireline and wireless computing devices that may be utilized to carry out any of the News ADS service processes associated with various embodiments of the invention. The distributed computing system 10 may include, but is not limited to, a first server device 12 which may be associated with a News Media Content (NMC) provider that may provide print and/or web publishing services, a second server device 14 that may be associated with a News ADS service, one or more wireline client devices 16a-c that may be associated with clientele of the first server device 12, one or more wireless client devices 18a-c that may be clientele of the first server device 12, a backbone network 20 that facilitates communications amongst the servers 12, 14, and the client devices 16a-c, 18a-c, one or more network router/switch devices 22 that can control data communications between the servers 12, 14, and the wireline client devices 16a-c, and one or more wireless basestations 24 that can control wireless communications between the servers 12, 14, and the wireless client devices 18a-c.

In an embodiment, the first and second server devices 12, 14, the wireless basestation 24, as well as any of the wireline and wireless client devices 16a-c, 18a-c, may be configured to run any known operating system, including but not limited to, Microsoft Windows™, Mac OS™, Linux™, Unix™, or any common mobile operating system, including Symbian™, Palm™, Windows Mobile™, Mobile Linux™, MXI™, etc. In an embodiment, the first and second server devices 12, 14, the wireless basestation 24 as well as any of the wireline client devices 16a-c may employ any number of common server, desktop, and laptop computing devices. In an embodiment, the wireless client devices 18a-c may include any combination of mobile computing devices, having wireless communications capabilities (e.g., cellular phones, PDAs, eBooks, ultra-portable computers, etc.).

In an embodiment, the backbone network 20 may include, but is not limited to, any of the following communications technologies: optical fiber, coaxial cable, twisted pair cable, Ethernet cable, power-line cable, and any microwave point-to-point technology known in the art. In an embodiment, the wireless basestation 24 may be configured to communicate with the wireless client devices 18a-c via any Cellular Data Communications Protocol, including any common GSM, UMTS, WiMAX or LTE protocol.

In an embodiment, the first and second server devices 12, 14, the wireless basestation 24, along with any of the wireline and wireless client devices 16a-c, 18a-c may also include any standard computing software and hardware necessary for processing, storing, and communicating data amongst each other within the distributed computing system 10. The computing hardware may include, but is not limited to, one or more processors, volatile and non-volatile memories, user interfaces, and wireline and/or wireless communications transceivers.

In an embodiment, the first and second server devices 12, 14, and the wireless basestation 24 may be configured to include a computer-readable medium (e.g., any common volatile or non-volatile memory type) encoded with a set of computer readable instructions, which when executed, performs one or more control processes associated with the News ADS processes of the present invention.

In accordance with various embodiments of the present invention, the NMC provider may include, in addition to news content providers, any of the following media content provider types without departing from the spirit and the scope of the present invention: a social networking content provider (e.g., Facebook™ or MySpace™), an entertainment content provider (e.g., YouTube™, Rhapsody™, or Pandora™), a personal interest content provider (e.g., any number of Blog or Twitter websites), etc. One skilled in the art should realize that additional computing devices (not shown) of the distributed computing system 10 could also be affiliated with an agent of NMC provider clientele. In this embodiment, an agent of the NMC provider clientele could substantially perform some or all of the processes associated with the NMC provider or the clientele without departing from the spirit and scope of the present invention.

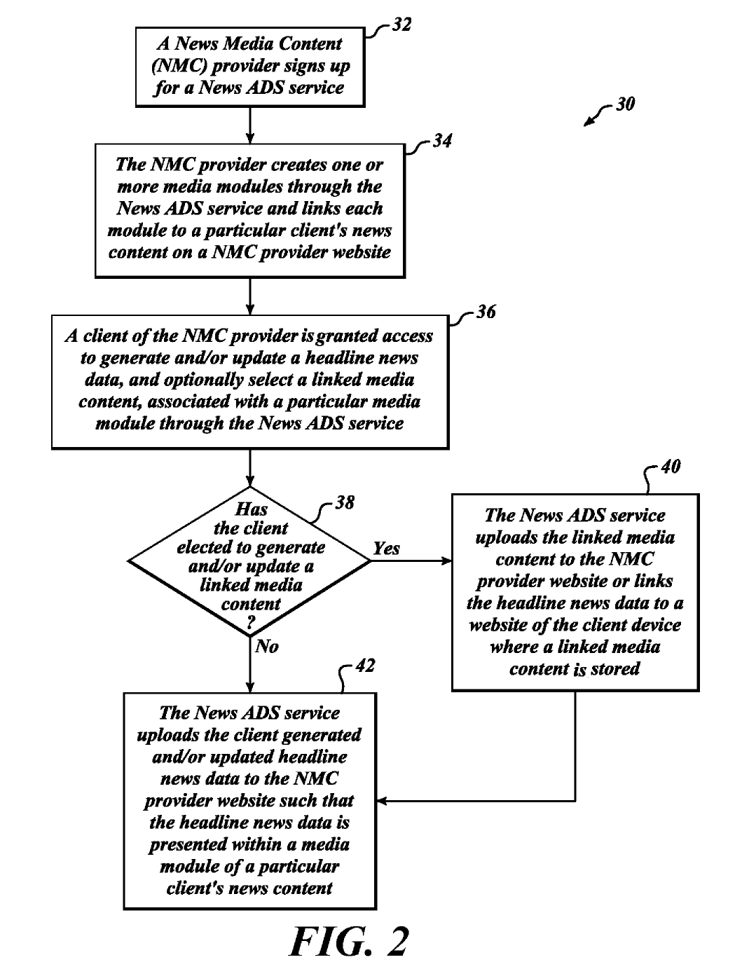

In accordance with an embodiment of the invention, FIG. 2 illustrates a flowchart process 30 associated with a News ADS service provided by the second server device 14 to any combination of the first server device 12 and the wireline and/or wireless client devices 16a-c, 18a-c. At block 32, a NMC provider (e.g., at the first server device 12) signs up for a News ADS service (e.g., provided by the second server device 14). In an embodiment, this process may include the NMC provider contacting the News ADS service via a common internet communication (e.g., by e-mail) or any other communications media (e.g., by telephone) to enroll/register themselves, their AD space (i.e., a webpage space designated for a News ADS generated media module), and their qualifying customers with the News ADS service. In this embodiment, a qualifying customer may be a customer who has purchased a News ADS media module service from the NMC provider. The purchased media module service may include one or more media modules that may be configured to be embedded within a NMC provider webpage using any web-based programming language, such as a HTML, XML, Javascript (e.g., an embedded Java applet), etc.

At block 34 the NMC provider may create one or more media modules through the News ADS service and then link each of the created media modules to a particular AD space designated for the media modules at a NMC provider webpage, and to a particular client (or agent of the client) of the NMC provider who is granted access to the News ADS service. In an embodiment, the NMC provider may specify to the News ADS service which clientele are able to post what types of news content to the different media modules residing on the NMC provider website webpages. At block 36 a client of the NMC provider may be granted access by the NMC provider to generate and/or update a headline news data associated with a particular News ADS generated media module presented within a NMC provider webpage. In an embodiment, the headline news data may be purely textual. In another embodiment, the headline news data may include other media type content, including, but not limited to, audio, audiovisual, and image data. In an embodiment, client generated headline news data may include headline content based on various web-based programming languages, such as a HTML, XML, or Javascript. Preferably, headline content generation (at the program-code level) may be black-boxed to clientele of a NMC provider, such that a client only needs to know how to input data into a simple News ADS service user interface that is associated with a server-side (second server device 14) application that executably performs the actual generation, updating, and linking functions of the present invention. Optionally, a client may also be granted access to select a linked media content to associate with a particular media module through the News ADS service.

At decision block 38 it is determined by the News ADS service if the client has elected to generate and/or update a linked media content associated with a particular media module through the News ADS service website. In an embodiment, a linked media content may be stored at either the NMC provider (e.g., at first server device 12) or at any of the client devices 16a-c, 18a-c. If a client chooses to generate and/or update linked media content then the process proceeds to block 40. At block 40, the News ADS service may upload the linked media content to the NMC provider website (e.g., at first server device 12) or link the headline news data to a website stored on the client device (e.g., at any of client devices 16a-c, 18a-c) where a linked media content may also be stored. In alternate embodiments, the linked media content may be stored at any number of remote server devices (not shown) which are capable of storing web-based media content. If the client chooses not to generate and/or update a linked media content at decision block 38, or if the processes of block 40 have already been executed, the process proceeds to block 42. At block 42 the News ADS service may upload the client generated and/or updated headline news data to the NMC provider website (e.g., at first server device 12), such that the headline news data is presented within a media module of a particular client's News Ad content. In an embodiment, the presentation of the headline news data within a media module may include embedding HTML, XML, or Javascript content into a predesignated webpage AD space at a NMC provider website (stored at first server device 12).

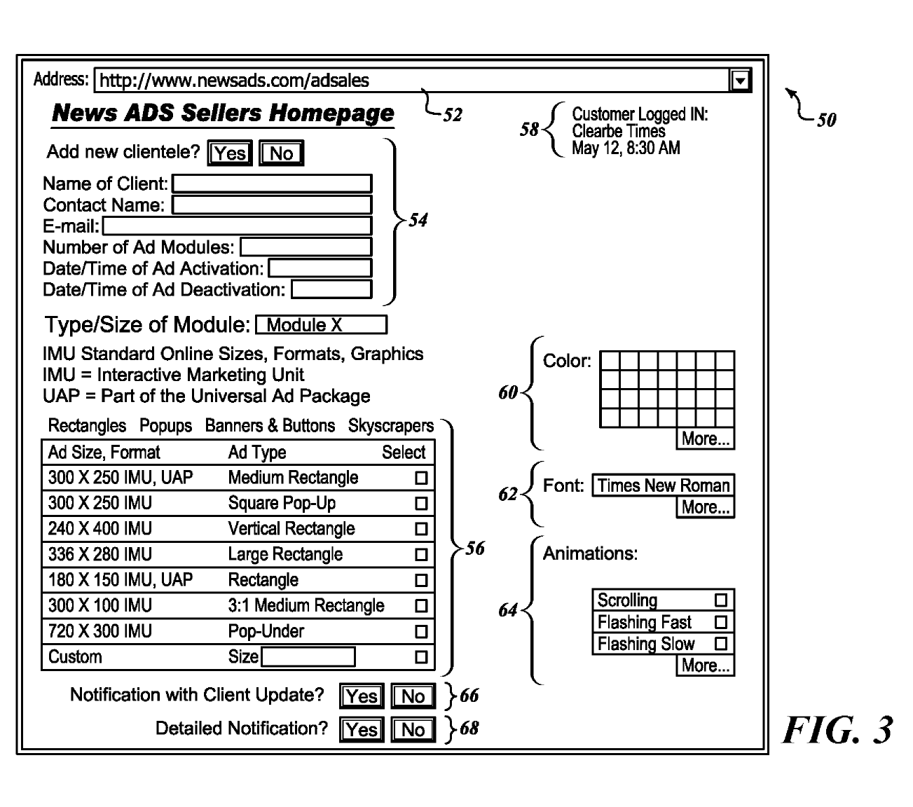

FIG. 3 illustrates an embodiment depicting a News ADS Sellers Homepage 50 that may be located at the second server device 14 which provides a News ADS service to any NMC provider that have signed up for a News ADS service. The News ADS Sellers Homepage 50 may include: a URL address field 52 designating the News ADS Sellers Homepage URL address; a new clientele registry component 54 that allows a registered NMC provider to enroll new clientele with the News ADS service; a news module selection component 56 that allows a registered NMC provider to select multiple and different types of media module components to associate with a particular client; a registered user information component 58 that may display a NMC provider status information; a text color swatch component 60 that allows a NMC provider to select a text color to associate with text to be presented at one or more client media modules; a font type component 62 that allows a NMC provider to select a specific font type to associate with one or more client media modules; an animations selection component 64 that allows a NMC provider to select one or more animations styles to associate with one or more client media modules; a general notifications component 66 that allows a NMC provider to select whether they wish to be notified by the News ADS service when a client updates their headline news data and/or their linked media content; a detailed notifications component 68 that allows a NMC provider to select whether they wish to be notified by the News ADS service of various detailed information associated with client updates. In various embodiments, the detailed notifications may include information pertaining to the type, date, or specific content of client updates.

In an embodiment, the new clientele registry component 54 may include information related to a name of a NMC provider client being registered, a contact name for the client, an e-mail or telephone contact for a client, a number and/or type of media modules a particular client has signed up for, a date and time of a media module activation, and a date and time of a media module deactivation. In an embodiment, the news module selection component 56 may include a client selection of AD space media module types (e.g., Banners, Buttons, Skyscrapers, Pop-ups, etc.) and sizes associated with different client-affiliated media modules. In an embodiment, an animations selection component 64 may include, but is not limited to, common GUI actions such as scrolling, flashing, changing color, highlighting, etc.

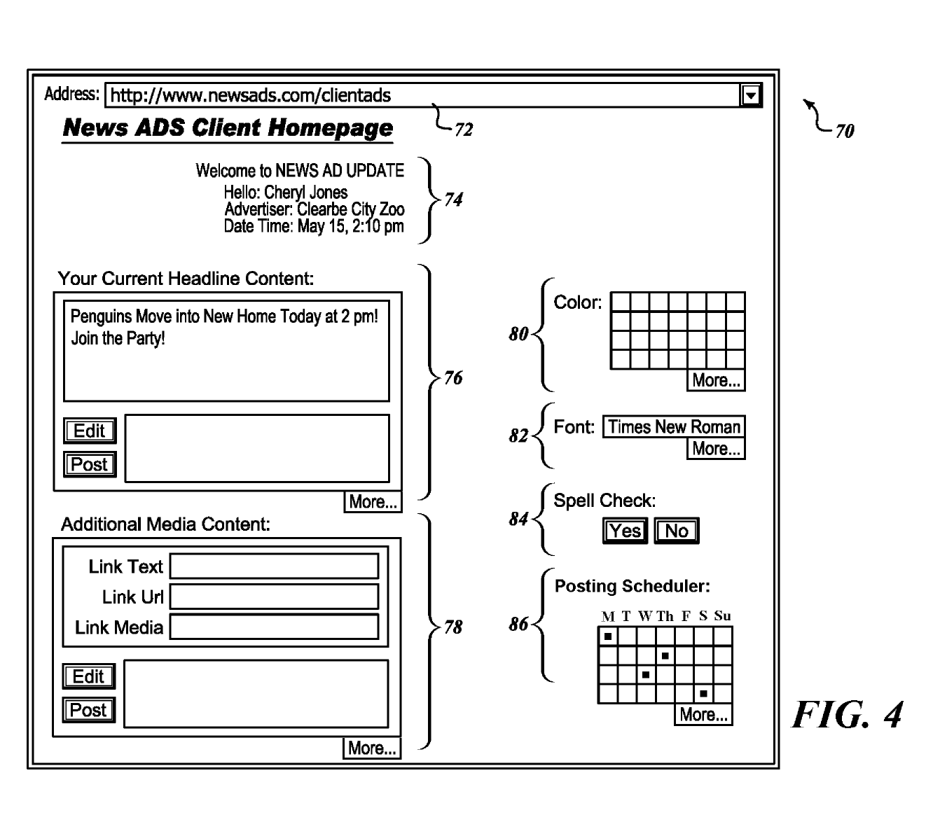

FIG. 4 illustrates an embodiment depicting a News ADS Client Homepage 70 which may be located at the second server device 14 that provides a News ADS service to any client of a registered NMC provider (e.g., client devices 16a-c and 18a-c) that have signed up for a News ADS service through the NMC provider. The News ADS Client Homepage 70 may include: a URL address field 72 designating the News ADS Client Homepage internet location URL address; a client welcome and status component 74 that may include information related to a client name, an affiliated NMC provider name, a date and time status, etc.; a current headline content update component 76 that allows registered clientele of a NMC provider to edit and repost existing headline news content and/or to generate and post new headline news content; an additional media content component 78 that allows a client to link and/or edit an additional media content to a news headline content associated with a particular media module at a NMC provider webpage (e.g., a webpage stored at the first server device 12); a client-side text color swatch component 80 that allows a NMC provider client to select any NMC provider approved text color to associate with text to be presented as headline news data in one or more affiliated media modules embedded in a NMC provider webpage; a font type component 82 that allows a NMC provider client to select any NMC provider approved font type to associate with one or more affiliated media modules embedded in a NMC provider webpage; a spell check component 84 that allows NMC provider clientele to spell check their headline news content and additional media content prior to posting any media content; a posting scheduler component 86 that allows clientele of a NMC provider to select a time and a date to schedule various headline news content and/or additional media content postings to specific media modules embedded in webpages of a NMC provider website.

In an embodiment, the current headline content update component 76 may include an Edit component, a Post component, and a More content component. The Edit component may facilitate a user typing within an existing headline content window to update existing headline news content. Alternately, a user may generate new headline news content in an empty headline content window. In an embodiment, when a user selects the Post component, an instance of a posting scheduler component 86 may be invoked, such that a user is able to schedule a specific time and date for an updated or newly generated headline news content to be uploaded to, and presented within, a media module of a webpage at a NMC provider website. In an embodiment, the More content component may facilitate a user editing multiple headline data associated with multiple media modules hosted at a NMC provider website (e.g., a website stored at first server device 12).

In an embodiment, the additional media content component 78 may include a link text component that may allow a user to designate a local device location where an additional text media content is stored; a link URL component that may allow a user to designate a URL location (e.g., a webpage location within a server-hosted website) where an additional media content is stored; a link media component that may allow a user to designate a local or a remote device location where an additional non-text media content (e.g., audio, audio-visual, or image media) may be stored, an edit component that may facilitate a user editing a text content (e.g., a media content description or a text media content) affiliated with any of a linked text, URL, or media content within an existing media content window. In an embodiment, the post component associated with the additional media content component 78 may invoke an instance of a posting scheduler component 86 that allows a user to schedule a time and date for linked or edited additional media content to be uploaded to a NMC provider server (e.g., first server device 12).

In an embodiment, the posting scheduler component 86 may be presented as a monthly or weekly calendar having daily and/or hourly time slots wherein a user of the News ADS Client Homepage 70 can enter scheduled media module postings to various NMC provider websites. When a client-scheduled posting is detected by the posting scheduler component 86 (e.g., when a scheduled date and time have been reached), the News ADS service may be prompted by the posting scheduler component 86 to automatically upload a scheduled media module content (e.g., an updated or new headline news data) to the first server device 12, such that the media module content is presented within an AD space on a webpage of a NMC provider website. In an embodiment, the posting scheduler component 86 may have several different postings scheduled for the same client at one or more NMC provider websites. In this way, a client may consolidate all of their news postings activities to one central website service location: their personal News ADS Client Hompage 70.

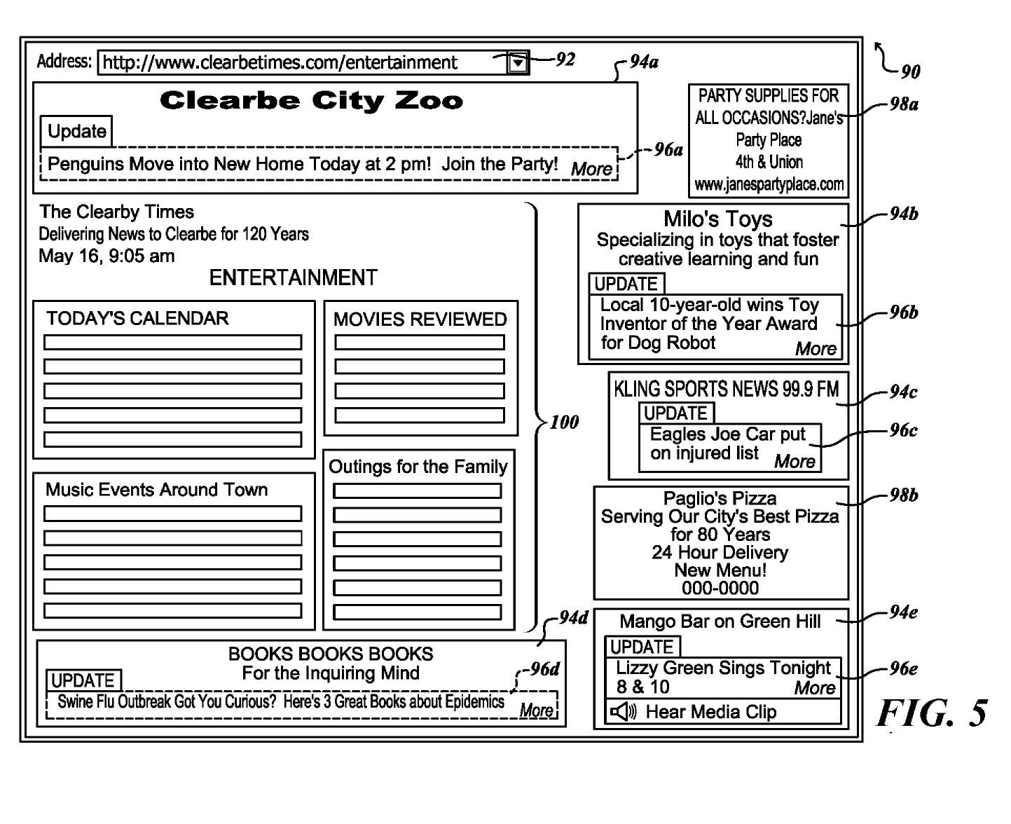

FIG. 5 illustrates a first view of NMC provider webpage 90 at 9:05 am on May 16, 2009. The NMC provider webpage 90 includes a URL address field 92 designating the “Clearbe Times” URL address, multiple dynamic News Ads 94a-e that each have embedded media modules 96a-e with headline news content at particular AD space locations within the respective dynamic News Ads 94a-e, multiple static News Ads 98a-e that each have static headline news data at particular AD space locations within the respective static News Ads 98a-e, and various static news media content 100 that is generated and presented by the “Clearbe Times” NMC provider. In an embodiment, the embedded media modules 96a-e of each dynamic News Ad 94a-e all have headline news content that individually conform to client specified headline news data preferences. For example, at 9:05 am, the Clearbe City Zoo News Ad 94a has an embedded media module 96a that has the following news headline: “Penguins Move into New Home Today at 2 pm! Join the Party!” The news headline may be scrolling or flashing and of a selected font color and type in accordance with a set of client specified headline content preferences on the Clearbe City Zoo News ADS Client Homepage (e.g., the preferences specified on the News ADS Client Homepage of FIG. 4).

The Clearbe City Zoo embedded media module 96a also has an Update notification component and a More content component. In an embodiment, the Update notification component is presented to inform a viewer of the Clearbe Times that the content of the Clearbe City Zoo News Ad 94a media module 96a has recently been updated. By showing the Update notification, a reader of the Clearbe Times can realize that they are viewing current news release information that is not stale like the static news content of the static News Ads 98a-e. In an embodiment, the More content component may be a hyperlink to an additional media content specified by Clearbe City Zoo on their News ADS Client Homepage of FIG. 4. In one embodiment, the hyperlinked additional media content is displayed on the Clearbe Times Website 90 as a pop-up component having an additional news story with images of Penguins enjoying their new habitat at the Clearbe City Zoo. In another embodiment, the hyperlinked additional media content is displayed on a Clearbe City Zoo Website (not shown) as a single website webpage having an additional news story with streaming video of Penguins enjoying their new habitat at the Clearbe City Zoo. In various embodiments, additional media content may be stored at any number of local or remote server device locations and this content may be displayed in response to a user hover over or a user click of the More content component in the Clearbe City Zoo News Ad 94a media module 96a.

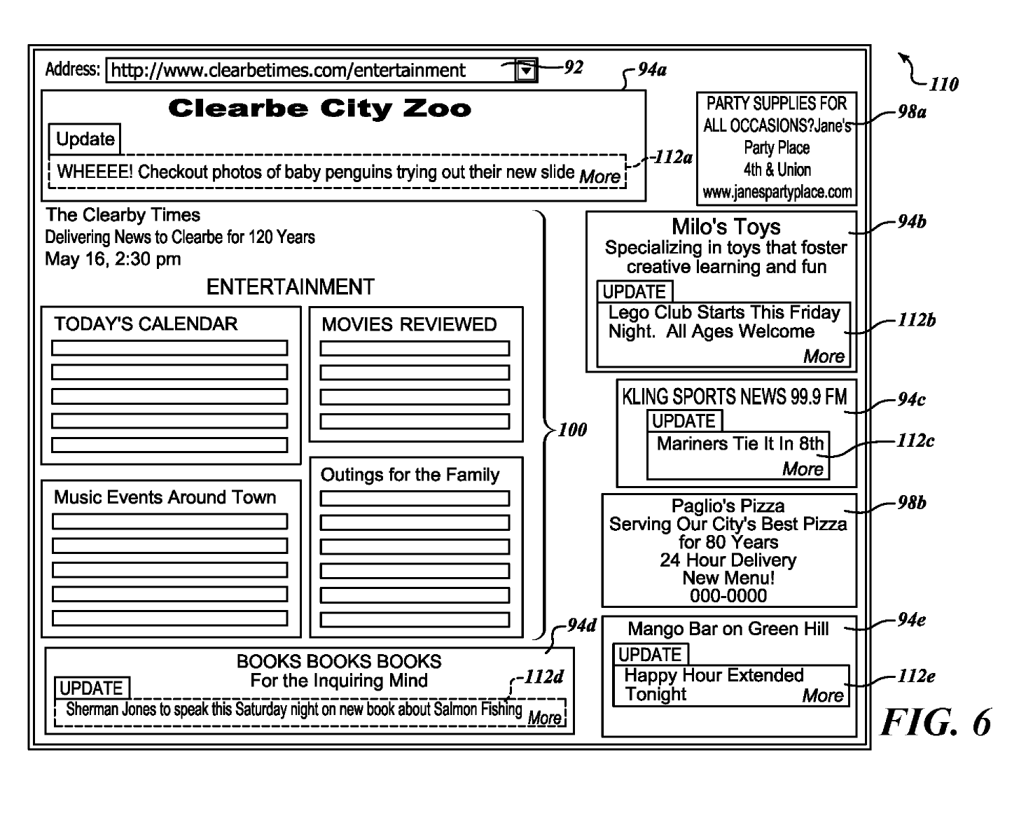

FIG. 6 illustrates a second view of NMC provider webpage 110 at 2:30 pm on May 16, 2009. The NMC provider webpage 110 includes a URL address field 92, multiple dynamic News Ads 94a-e that each have further updated embedded media modules 112a-e with different headline news content from that of FIG. 5, multiple static News Ads 98a-e that each have static headline news data, and static news media content 100 that is presented by the “Clearbe Times” NMC provider. In an embodiment, the embedded media modules 112a-e each have updated headline news content. At, 2:30 pm, the Clearbe City Zoo News Ad 94a has an updated embedded media module 112a that has the following news headline data which is different from the 9:05 am news headline: “WHEEE! Checkout photos of baby penguins trying out their new slide.” The updated news headline may be designated to change color from black to red to attract Clearbe Times readers' attention in accordance with a set of client-specified headline content preferences on the Clearbe City Zoo News ADS Client Homepage of FIG. 4. Similar to the updated Clearbe City Zoo News Ad 94a media module 112a, the other dynamic News Ads 94b-e all have different headline content in their respective media modules 112b-e at the two scheduled posting times of 9:05 am and 2:30 pm.

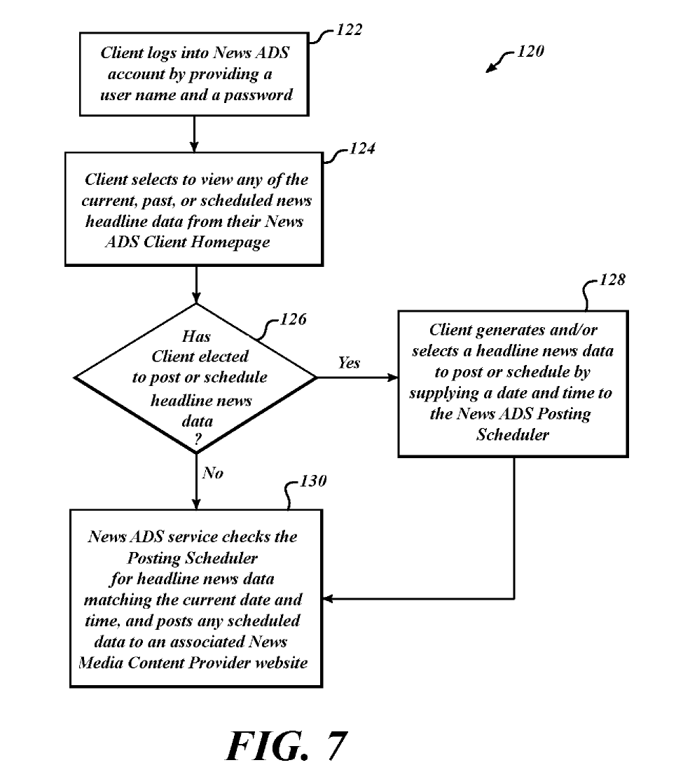

In accordance with an embodiment of the invention, FIG. 7 illustrates a flowchart process 120 associated with a News ADS service provided by the second server device 14 to any of the wireline and/or wireless client devices 16a-c, 18a-c. At block 122, a registered client may log into their News ADS service by providing an accepted user name and a password at a login user interface (not shown). At block 124 a client may select to view any of their current, past, or scheduled news headline data from their News ADS Client Homepage (e.g., News ADS Client Homepage of FIG. 4). Next, at decision block 126 a client determines whether or not to immediately post or schedule a posting of a headline news data. If the client decides to post or schedule headline news data the process proceeds to block 128, and the client generates or selects a news headline data to post or schedule by supplying a specific date and time to a News ADS posting scheduler (e.g., posting scheduler component 86). If the client decides not to post or schedule headline news data or the client has already posted or scheduled news headline data at block 128, the process proceeds to block 130 where the News ADS service is notified by the posting scheduler when scheduled headline news data matches the current data and time. If the posting scheduler indicates that the a news headline data is due to be posted based on the date and time criteria, the News ADS service uploads/posts any scheduled news headline data along with any affiliated additional media content to an associated NMC provider website.

Those skilled in the art should realize that the various embodiments of the present invention allow a client (or agent of the client) of a NMC provider to easily and continually refresh important news headline data on a portion of their News Ad at a NMC provider website with little to no interaction on the part of the NMC provider. After a NMC provider and their client set up their respective News ADS service accounts and the NMC provider sets their client Ad preferences (e.g., pertaining to various client media modules) at their News ADS Sellers Homepage (e.g., FIG. 3), all the client needs to do is log into their account to access their News ADS Client Homepage (e.g., FIG. 4) to quickly and easily create or change their news headline data and additional media content. In various embodiments NMC provider clientele may be able to generate and modify multiple News Ads hosted at a variety of NMC provider websites from the same News ADS service homepage.

While several embodiments of the present invention have been illustrated and described herein, many changes can be made without departing from the spirit and scope of the invention. Accordingly, the scope of the invention is not limited by any disclosed embodiment. Instead, the scope of the invention should be determined from the appended claims that follow.

The embodiments of the invention in which an exclusive property or privilege is claimed are defined as follows:

1. A system for distributing readily updatable media content, the system comprising:
a first server device;
a second server device;
at least one client device; and
a data communications network facilitating communications amongst the first server device, the second server device, and the at least one client device,
wherein the second server device provides an updatable media content service to the first server device and the at least one client device, such that a media content selection of the at least one client device is presented within a news media content of the first server device.

2. The system of claim 1, wherein the media content selection is textual headline data generated by a user of the at least one client device.

3. The system of claim 1, wherein the presentation of the media content selection within the news media content of the first server device requires substantially no input from the first server device.

4. The system of claim 1, wherein a linked media content is presented in response to a user selection of the media content selection within the news media content of the first server device.

5. The system of claim 4, wherein the linked media content is stored at the first server device.

6. The system of claim 4, wherein the user selection of the media content selection within the news media content of the first server device links the user to a URL site comprising the linked media content.

7. The system of claim 6, wherein the URL site comprising the linked media content is associated with a website of the at least one client device.

8. A computer-readable medium encoded with a set of computer-executable instructions, which when executed, perform a method for distributing readily updatable media content, the method comprising:
providing an updatable media content service to a first server device and at least one client device from a second server device over a data communications network;
selecting a media content from the at least one client device; and
presenting the media content selection within a news media content of the first server device.

9. The computer-readable medium of claim 8, wherein the media content selection is textual headline data generated by a user of at least one client device.

10. The computer-readable medium of claim 8, wherein the presentation of the media content selection within the news media content of the first server device requires substantially no input from the first server device.

11. The computer-readable medium of claim 8, wherein the method for distributing readily updatable media content further comprises, presenting a linked media content in response to a user selection of the media content selection within the news media content of the first server device.

12. The computer-readable medium of claim 11, wherein the linked media content is stored at the first server device.

13. The computer-readable medium of claim 11, wherein the user selection of the media content selection within the news media content of the first server device links the user to a URL site comprising the linked media content.

14. The computer-readable medium of claim 13, wherein the URL site comprising the linked media content is associated with a website of the at least one client device.

15. A method for distributing readily updatable media content, the method comprising:
providing an updatable media content service to a first server device and at least one client device from a second server device over a data communications network;
selecting a media content from the at least one client device; and
presenting the media content selection within a news media content of the first server device.

16. The method of claim 15, wherein the media content selection is textual headline data generated by a user of the at least one client device.

17. The method of claim 15, wherein the presentation of the media content selection within the news media content of the first server device requires substantially no input from the first server device.

18. The method of claim 15, further comprising presenting a linked media content in response to a user selection of the media content selection within the news media content of the first server device.

19. The method of claim 18, wherein the linked media content is stored at the first server device.

20. The method of claim 18, wherein the user selection of the media content selection within the news media content of the first server device links the user to a website of at least one client device comprising the linked media content.
